(19) United States
(12) Patent Application Publication
(10) Pub. No.: US 2015/0046569 A1
(43) Pub. Date: Feb. 12, 2015

(54) EASY RADIO STATION NETWORK

(71) Applicant: Live365, Inc., Foster City, CA (US)

(72) Inventors: Hong Thye Lau, North Vancouver (CA); Jeffrey Chi Fai Tam, San Francisco, CA (US); Kevin Liao, Foster City, CA (US)

(73) Assignee: LIVE365, INC., Foster City, CA (US)

(21) Appl. No.: 14/457,062

(22) Filed: Aug. 11, 2014

Related U.S. Application Data
(60) Provisional application No. 61/865,098, filed on Aug. 12, 2013.

(51) Int. Cl. H04L 29/06; G06F 3/0484

(52) U.S. Cl. CPC H04L 65/60; G06F 3/0484; G06Q 30/0241
USPC 709/219

(57) ABSTRACT

A method and system for providing a digital platform including interactive tools to a plurality of consumers to enable a consumer to be a broadcaster of content, via streaming, by hosting a personal radio station of the consumer and simultaneously to be a consumer of content broadcasted, via streaming, by other consumers are disclosed. The content can include music, video, graphics, photographs, slide show, audio and other multimedia content.

### CROSS REFERENCE TO RELATED APPLICATIONS

This application claims the benefit of U.S. Provisional Patent Application No. 61/865,098 filed Aug. 12, 2013, entitled, “Easy Radio Station Network,” by Lau et al., and which is hereby incorporated by reference in its entirety.

### TECHNICAL FIELD

The present invention is directed to electronic communications, and more specifically to aspects of digital media broadcasting technology network tools and application.

### BRIEF DESCRIPTION OF THE DRAWINGS

FIG. 1A illustrates a convenient way for a consumer to personalize her radio station by using the radio network system, according to certain embodiments.

FIG. 1B illustrates interaction and social engagement between a plurality of users of the radio network system, according to certain embodiments.

FIG. 1C illustrates a plurality of users of the radio network system forming a network of computer-implemented personal radio stations, according to certain embodiments.

FIG. 1D illustrates the viral aspect of the distribution of content through station-to-station proliferation, according to certain embodiments.

FIG. 1E illustrates some high-level aspects of selecting curated playlists by a user to get the user started on using the radio network system to create her own personal radio station, according to certain embodiments.

FIG. 2 illustrates aspects of a user's computer-implemented personal radio using the radio network system and associated service, according to certain embodiments.

FIG. 3 illustrates some customization features of the radio network system and its associated subscription service, according to certain embodiments.

FIGS. 4A-C illustrate some of the features offered by the radio network system that make broadcasting from a computer-implemented personal radio station interesting to the user's audience, according to certain embodiments.

FIG. 5 illustrates a listener's player or a broadcaster/user's player with a mood skin, according to certain embodiments.

FIG. 6 illustrates features based on sponsorship, according to certain embodiments.

FIG. 7 illustrates a broadcaster/user's player or a listener's player that includes a photo slideshow display, according to certain embodiments.

FIG. 8 illustrates a user's use of multiple channels enabled by the radio network system and its associated service, according to certain embodiments.

FIG. 9 illustrates a way for a user to project her voice into her computer-implemented radio program, according to certain embodiments.

FIG. 10 illustrates the use of the radio network system in partnership with various computer-implemented radio companies, according to certain embodiments.

### DETAILED DESCRIPTION

According to certain embodiments, a radio network system enables any individual to host her own radio station (“personal radio station”) to broadcast, with relative ease, her own personal radio show to anyone and everyone that is willing to tune in. Further, such a radio network system enables the individual, using a few easy steps, to include into her personal radio show content from other radio shows (referred to as “borrowed content” herein) hosted by other individuals using such a radio network system. Additionally, in such a radio network system, the ease of hosting personal radio stations coupled with the ease of creating, distributing, exchanging and borrowing content amongst radio stations induces a natural proliferation of personal radio stations that are in communication with each other and results in a vast network with potentially millions of radio stations that are capable of interacting with one another. Similarly, any group of individuals, company, institution, or entity can use such a radio network system in the manner described above. Such a radio network system is simultaneously a broadcasting and listening platform that can provide both broadcasting and listening functions to facilitate extensive networking and social interaction.

According to certain embodiments, the ease of hosting and creating a personal radio station creates great interest and participation in the consumer community because: (1) anyone can become a radio show host, free to expound on any topic in any genre and in any format desired by the consumer, and (2) the radio show host can interact with other radio show hosts and listeners in engaging and interesting ways to build community through such a radio network system. For example, the consumer/individual can create her personal radio show by including into the show: (1) her commentary on any subject she desires, (2) story telling, (3) music that she has created or that others have created, (4) guest interviews, (5) announcements, (6) opinion-editorials, etc. Consumers/individuals can include into their personal radio shows content related to any topic, including community events, culture, art, trivia, entertainment, politics, religion, policy, philosophy, sports, education, history, science, etc. Thus, worldwide communities based on members' geographic locations and/or interests in myriad issues and topics can form through use of the radio network system

Other ways of sharing and distributing content can include one or more of: (1) using shout outs, shout backs, call-ins (e.g., live talk shows), in a multi-level, and/or multi-directional communication network (with content communicated vertically and/or horizontally in a network of computer-implemented radio stations); (2) accessing other stations' content, (3) modifying content in one's own station; (4) featuring certain content among the stations; (5) listing and organizing certain content; (6) showing various data and metrics such as the most accessed station(s) in various categories (such as musical genres); (7) enabling transactions relating to one's content; and (8) using other functions. Shout-out and shout-back messages are described in provisional application, or entitled “Multi-Level Media Communications Content and Message Delivery and Response” by Kevin Liao et al., and having Application Ser. No. 61/757,211, and which is incorporated by reference herein in its entirety. According to certain embodiments, a consumer can include content created by others (e.g., personal radio stations of other people/entities) into her personal radio show as described in provisional application, or entitled “Integrated Content Provider-Distributor Network” by Foranev et al., and having Application Ser. No. 61/775,583, and which is incorporated by reference herein in its entirety. Thus, the above features are conducive to the formation of radio station networks. According to certain embodiments, the above features can be integrated into a streaming media environment and/or into an on-demand environment, both having global reach.

Another way of building community and interacting/communicating with each other is when consumers/individuals modify borrowed content in various ways for inclusion into their own radio shows. Modification of borrowed content can include any combination of: (1) integrating different subsets of borrowed content from other radio stations in the network or sources, (2) modifying the substance of borrowed content, (3) augmenting borrowed content with other content such as music, video, graphics, etc., (4) changing the format of borrowed content, etc. The sharing of content may be within a certain network/community (intra-network) or between networks/communities (inter-network). Thus, such a radio network system eliminates most of the significant barriers to creating and operating a personal radio station, providing a new means of self-expression to potentially millions. Further, the resulting multiplicity of radio stations supply and broaden the marketplace of ideas by increasing the amount of available content offered within, among, and across communities. More content increases and enhances listener choices and experience.

According to certain embodiments, such a radio network system, as described in further detail herein, can include using technologies such as the internet, WLANs, WiFi, WPAN, VPNs, WANs, LANs, satellite, wireless transmission over radio waves, etc. According to certain embodiments, such a radio network system may be computer-implemented. The personal radio stations may be computer-implemented. For example, any consumer can use such a radio network system to broadcast and/or listen to content using either a mobile device (non-limiting examples include smart phone, tablet, Kindle, Roku device, Tivo device, Apple TV device), any internet-enabled device, or desktop computer.

Such a radio network system is easy to set up and easy to use making it an ideal broadcast and listening system for creating a viral distribution network of radio stations for existing broadcasters, new broadcasters and listeners alike. In other words, any consumer can be a radio disk-jockey (DJ), sports commentator, media commentator, or radio broadcaster on any topic by using such a radio network system.

According to certain embodiments, any user can use such a radio network system to share ideas/content and socially engage with other users via their respective personal radio stations. For example, assume that User A uses her personal radio station to tell a story (e.g., a folk tale from her native China). A listener, User B, hears the Chinese folk tale and recalls a similar tale from her native Persia (modern day Iran). User B decides to comment on User A's Chinese folk tale. As an example, User B can either re-broadcast the Chinese folk tale (“borrowed content”) with her added her comments or broadcast an augmented version of the Chinese folk tale based on the Persian version of the folk tale. Thus, User A and User B can engage with each other in an interesting and fun manner via their respective personal radio stations. Further, any number of listeners that heard User A's Chinese folk tale and User B's augmented version of the folk tale can in turn engage with each other and with User A and User B by broadcasting their own comments or augmentations of the folk tale through respective personal radio stations. Thus, User A's original broadcast of the Chinese folk tale is able to spark a lively “conversation” in the form of radio shows between a multitude of users via such a radio network system. In other words, ideas and content can “go viral” via a multiplicity of personal computer-implemented radio stations, where the radio stations themselves can form a virally propagating network.

As another example, assume that a university uses such a radio network system for broadcasting ideas, messages, and other content to its university students. Those university students, using their respective personal computer-implemented radio stations, can in turn, engage with other members of the university by broadcasting comments on such ideas, messages, and other content to their friends, family and other members of the community associated with such users. Members of the community using their respective personal computer-implemented radio stations, can in turn, add content and/or augment/comment and/or re-broadcast such ideas, in whole or in part, to members in other communities in different parts of the world. Similarly, the university can use such a radio network system to interact and engage with other universities in different parts of the world by broadcasting content using the personal radio station. Such universities, using their respective personal radio stations, can in turn, engage with members of their respective communities by augmenting/commenting and/or re-broadcasting the content (and/or adding new content), in whole or in part, to their own respective communities and audiences. Such respective audiences using their respective personal computer-implemented radio stations, can in turn, engage with each other by augmenting/commenting and/or re-broadcasting the content (and/or adding new content), in whole or in part, to their communities, and so on. Thus, the use of such a radio network system and associated subscription service can enable a viral proliferation of personal computer-implemented radio stations (a “viral” network) by which users can interact with each other through sharing original content, re-broadcasting borrowed content, augmenting borrowed content, and personalizing content, according to certain embodiments.

According to certain embodiments, the personal computer-implemented radio stations in the viral radio network system have the option of providing, to each other, rights to access each other's content and/or rights to insert content into each other's broadcast stations and/or streams.

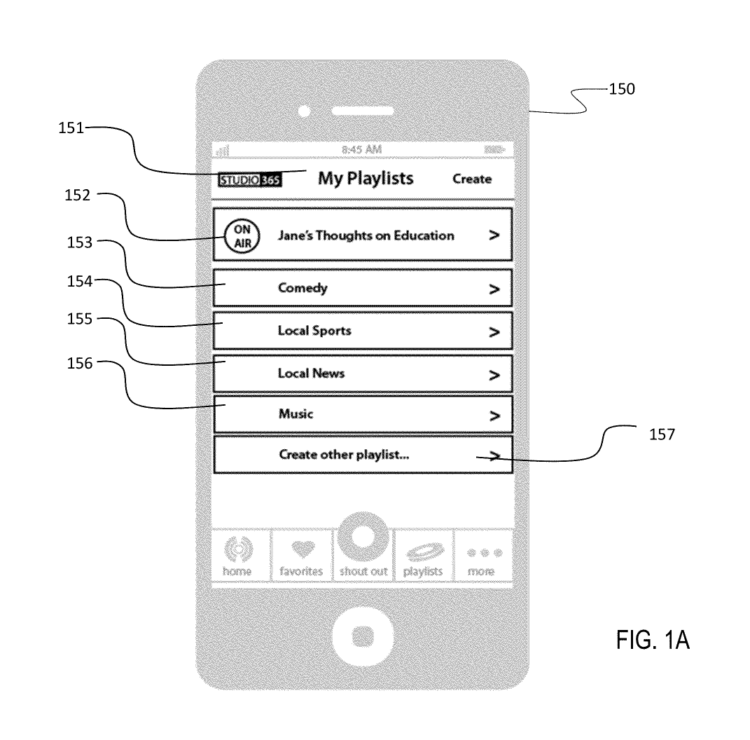

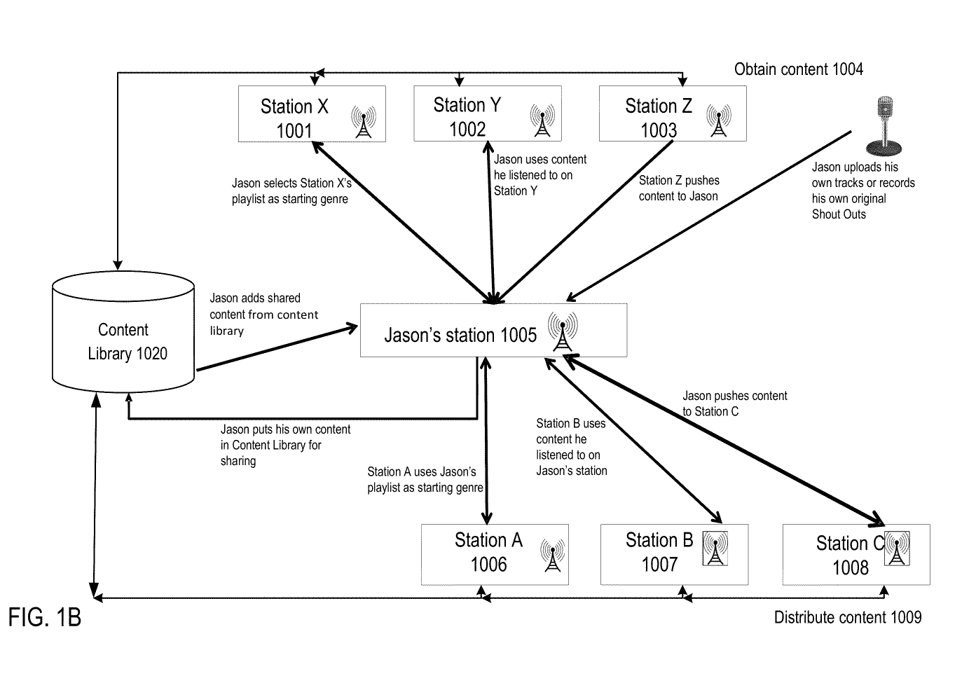

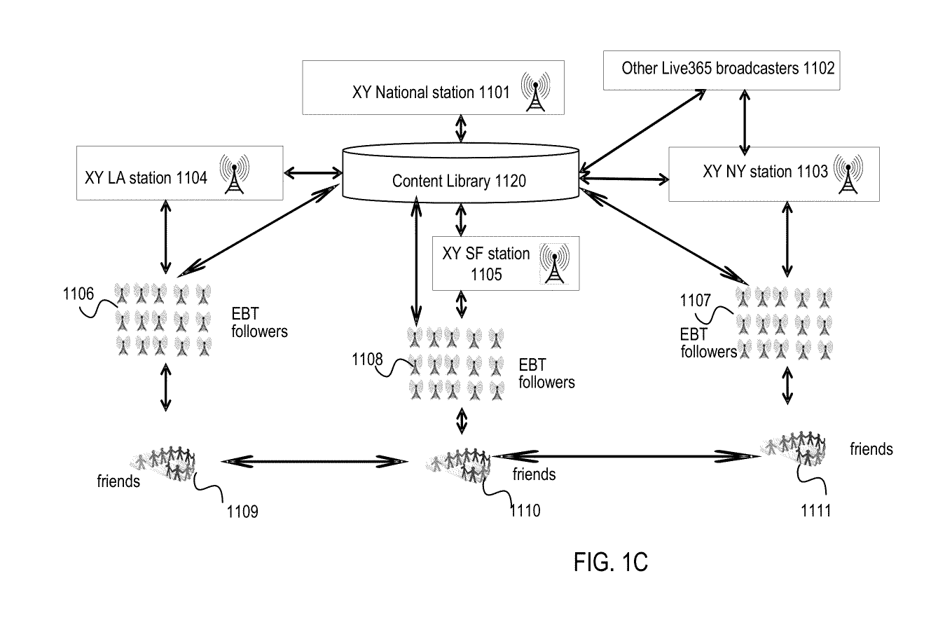

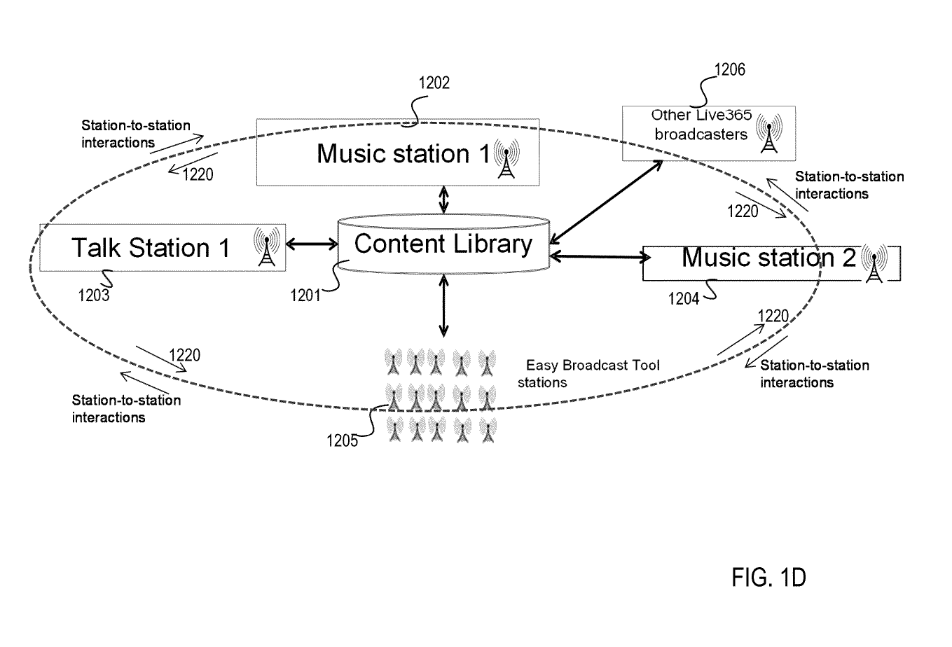

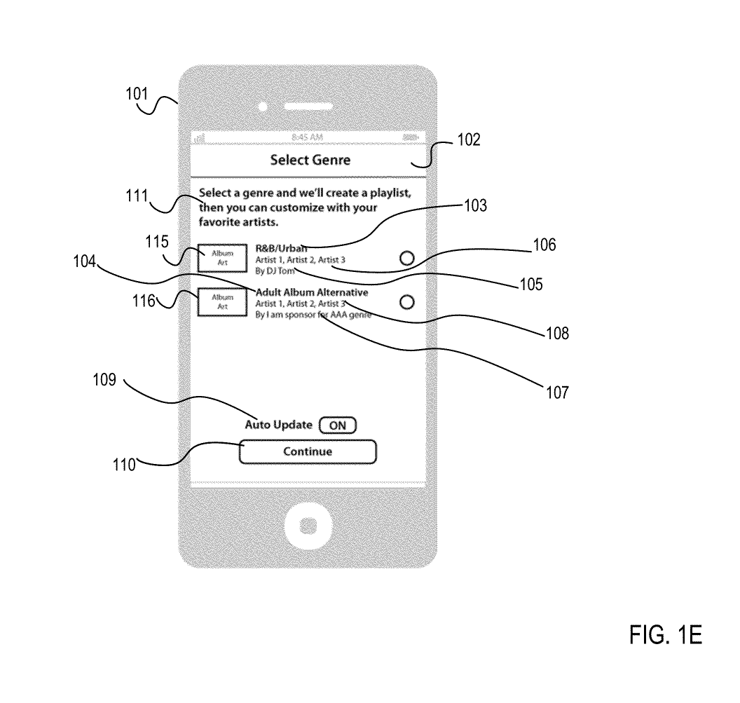

FIG. 1A illustrates a convenient way for a consumer/user/listener/broadcaster to personalize/customize her personal radio station by using the radio network system, according to certain embodiments. For purposes of explanation, assume that GUI 150 of FIG. 1A shows consumer/user/listener/broadcaster Jill's personal radio station that Jill easily personalizes to include several channels (151) by using such a radio network system. As a non-limiting example, Jill personalizes her personal radio station to include her friend Jane's educational station (152), a comedy station (153) of Jill's choice, a local sports station (154) of Jill's choice, a local news station (155) of Jill's choice, a music station (156) of Jill's choice, and other content or stations (157) of Jill's choice. Further, Jill can change the personalization/customization of her personal radio station at any time and as frequently as she chooses.

FIG. 1B illustrates interaction and social engagement between a plurality of users of the radio network system, according to certain embodiments. For ease of explanation, user interaction is described with respect to Jason's Station 1005. Jason's Station (1005) is a personal computer-implemented radio station in the radio network system. Similarly, for purposes of explanation, Station X, Station Y, Station Z, Station A, Station B, Station C (1001, 1002, 1003, 1006, 1007, 1008) are personal computer-implemented radio stations of a plurality of stations in the radio network system. The embodiments are not limited to the number and type of stations shown in FIG. 1B. As an example of interaction and social engagement between personal radio stations, Jason's Station can obtain (1004) content (multimedia content or single media content) from some of the other radio stations, such as Station X, Station Y, Station Z, of the plurality of personal radio stations. As a non-limiting example, Jason can select Station X's content (e.g., a folk tale or political commentary, or music playlist) as a starting genre. Jason can comment on and/or augment the content that he selected. Jason can pull into his station, from Station Y, content he was listening to on Station Y. Station Z may decide to push content to Jason's Station. Jason may decide to pull in to his station shared content from content library 1020. Jason also has the option of uploading to his station his own content tracks and/or other content that he owns, and/or Jason can record shout outs. Thus, Jason's Station can engage with his own station's listeners and/or other stations by broadcasting some or all of above content that he obtained or created. Some of the listeners may be using their own personal computer-implemented radio stations to engage with each other and with other users by augmenting/commenting and/or re-broadcasting the content (and/or adding new content), in whole or in part. For example, content associated with Jason's Station can be distributed (1009) to other stations for augmenting/commenting and/or re-broadcasting as follows. As a non-limiting example, Station A can select Jason's Station content as a starting genre to broadcast from Station A. Station A can comment on and/or augment the content that she selected. Station B can pull in, from Jason's Station, content that Station B was listening to Jason's Station. Jason may push content from Jason' Station to Station C. Jason may decide to download some of his content to content library 1020 so that such content can be shared with other stations. Thus, the example illustrated by FIG. 1B shows the viral proliferation aspect of using personal computer-implemented radio stations for interaction and social engagement between users of personal radio stations.

FIG. 1C illustrates a plurality of users of the radio network system forming a network of computer-implemented personal radio stations, according to certain embodiments. Assume a national organization XY has a national computer-implemented personal radio station (1101). Assume that XY national organization has chapter organizations in New York, Los Angeles, and San Francisco, with each chapter operating a computer-implemented personal radio station (1103, 1104, 1105). Assume that the XY national organization can store and distribute content at content library (1120) and each of the chapter computer-implemented personal radio stations (1103, 1104, 1105) has access to content library (1120). Further assume that a group of users (1102) that have computer-implemented personal radio stations also have access to content library (1120). Assume that listeners that tune into the chapter radio are themselves hosting their own computer-implemented personal radio stations. For example, each of one or more of the Los Angeles listeners can broadcast XY organization content (augmented or otherwise) as well as other content through their computer-implemented personal radio stations (1106) to their respective friends (1109). Similarly, each of one or more of the San Francisco listeners and New York listeners can broadcast XY organization content (augmented or otherwise) as well as other content through their computer-implemented personal radio stations (1108, 1107) to their respective friends (1110, 1111). Each of the one or more friends can, in turn, broadcast XY organization content (augmented or otherwise) as well as other content through their computer-implemented personal radio stations, and so on. Thus, the example illustrated by FIG. 1C shows the viral proliferation aspect of using computer-implemented personal radio stations for social interaction and communication. According to certain embodiments, all or a subset of listeners/broadcasters (1106, 1107, 1008) and respective friends (1109, 1110, 1111) may be given certain access rights to upload multimedia content (audio or text or video or graphics or photos or some combination thereof) to one or more content libraries associated with any of the stations (1101, 1103, 1004, 1005). According to certain embodiments, all or a subset of listeners/broadcasters (1106, 1107, 1008) and respective friends (1109, 1110, 1111) may be given additional access rights to insert multimedia content into the broadcast stream of one or more of the stations (1101, 1103, 1004, 1005). According to certain embodiments, all or a subset of listeners/broadcasters (1106, 1107, 1008) and respective friends (1109, 1110, 1111) may give access rights to each other to insert multimedia content into their respective broadcast streams associated with their computer-implemented personal radio stations. In other words, even though each computer-implemented personal radio station has an owner or administrator, multiple people may contribute multimedia content to a respective station, according to certain embodiments.

FIG. 1D illustrates the viral aspect of the distribution of content through station-to-station proliferation, according to certain embodiments. FIG. 1D shows music station #1 (1202), music station #2 (1204), talk radio station #1 (1203), users (1205, 1206) that operate computer-implemented personal radio stations can exchange/buy/sell content with each, as shown by the station-to-station interaction 1220. For example, any station can select content from the content library (1201) and/or select content directly from another station so as to include such selected content for broadcast through their computer-implemented personal radio stations. For example, a user/broadcaster “Jane” may be listening to content broadcast from another user's (“Joe's”) computer-implemented personal radio station, upon which, Jane decides to pull in content from Joe's station to add to Jane's own personal radio station.

According to certain embodiments, any consumer that has internet access or some other network access can use such a radio network system to create and customize her/his own personal radio station to broadcast content that the consumer created or borrowed, music that the consumer created, music that the consumer has previously purchased, an/or professional customizable playlists, as described in greater detail herein. Further, the consumer can use her/his created radio station to relay other radio stations created by other consumers or by existing broadcasters as described below. The consumer can also use her/his created radio to “shout out” messages and/or include “shout back” messages in her/his broadcast stream.

Existing broadcasters or consumers that wish to share/communicate with others through personalized broadcasting (herein generally referred to as “users”) can quickly and conveniently access a personalized computer-implemented and networked radio station through the use of the radio network system that is described herein. For example, such easy access to the radio network system can be facilitated through a short setup procedure as part of the provisioning process. The user can register for the radio network system through a social network service websites (e.g., Facebook, LinkedIn, Twitter, etc) of which the user is already a member to pull information and photos from the user's social network account and profile to personalize the user's newly created station, as an option. Thus, the user need only provide information in a small number of fields to register for the radio network system and associated subscription service.

According to certain embodiments, when a user registers for the radio network system, the user gains immediate access to a network of available, professionally programmed playlists that the user has the option of customizing. The playlists referred to herein can be audio content only or multimedia content (e.g. some combination of audio, video, graphics, photos, text, animation, etc.). At least a subset of the playlists may be curated by popular existing DJs and broadcasters, for example. The user can use such a radio network system to meet and communicate with listeners and other DJ's (existing DJ's/broadcasters and/or amateur DJ's, all of whom are users that are using the radio network system).

According to certain embodiments, the types of consumers/users/listeners/broadcasters of such a radio network system include active communicators that use online tools for communication, active participants of social networks, music lovers, mobile phone junkies, active sharers of music and other multimedia content, and users that would like to personalize, customize and exert more control over their content, playlists and station. For example, a consumer/user/listener/broadcaster can personalize her/his personal radio station by “skinning” the audio player or multimedia content player experience that the consumer's audience can see, as described in greater detail herein.

FIG. 1E illustrates some high-level aspects of selecting curated playlists by a user to get the user started on using the radio network system, according to certain embodiments. FIG. 1E shows aspects of a graphical user interface (GUI 101) of the radio network system on a mobile smart phone. As part of the radio network system, the user can select a genre of music or genre of multimedia content (102). When the user selects a genre, the radio network system will create a playlist for the user in the selected genre or offer the user a professionally pre-curated playlist in the selected genre (111). For purposes of illustration, GUI 101 shows various genres (103, 104), only two of which are shown, and album art (115, 116). The user can swipe the screen of the device to show more selectable genres. Each genre shows a list of artists (106, 108), the DJ or broadcaster that curated the playlist (105), or the sponsor of the playlist (107), according to certain embodiments. A sponsor is an entity that may pay for the subscription service associated with the radio network system so that the user does not have to pay for it. The radio network system includes an automatic update feature (109). The user has the option of activating such an “auto update” feature to automatically receive updates from the original curator of the playlist to the user's selected playlists. The features of the radio network system are not limited to those shown in FIG. 1E and can vary from implementation to implementation. Some of the features are optional.

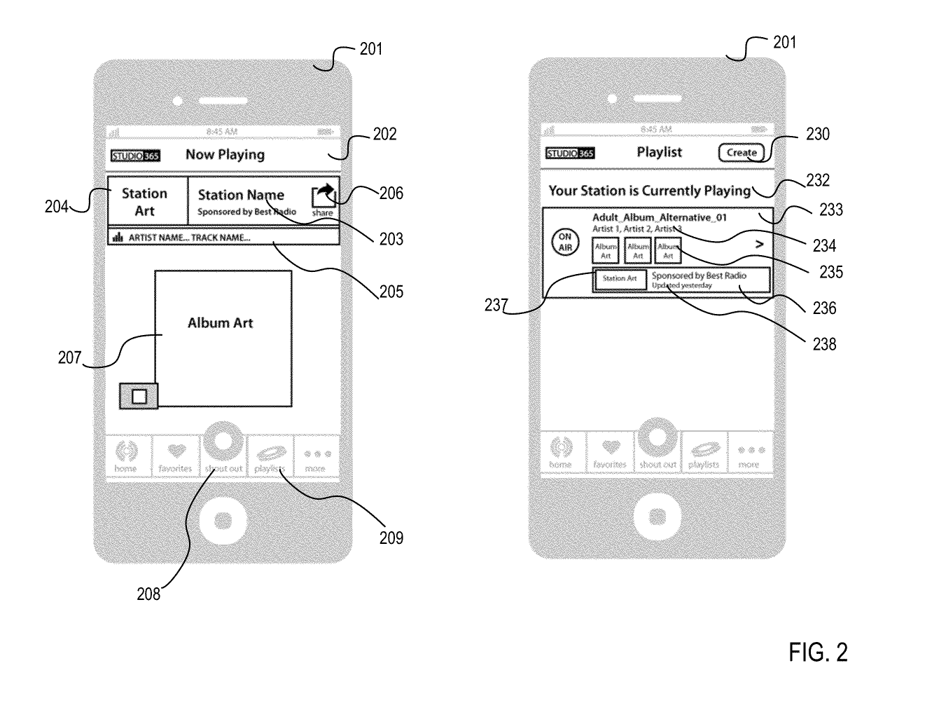

FIG. 2 illustrates aspects of a user's computer-implemented personal radio using the radio network system and associated service, according to certain embodiments. FIG. 2 shows GUI (201) of a user's computer-implemented personal radio station. GUI (201) shows the current status of the computer-implemented personal radio (202, 232). The user can customize her personal radio station by giving it a name (203) and include station art (204). GUI (201) also shows the track name and artist name (205) of the content (e.g., song) track that is currently playing from one of the user's playlists, according to certain embodiments. GUI (201) can also display art (e.g., album art) (207). The user has the option of broadcasting/sharing her computer-implemented personal radio content by activating the “share” feature (206). The user can change the current playlist that is on the air (233) by selecting another playlist (209). GUI (201) also shows the artists names (234), corresponding album art (235) in the selected genre playlist (233). GUI (201) can also show station art (237), the name of the playlist sponsor or curator (236) and show when the sponsored/curated playlist was last updated (238). The user has the option of creating or customizing (230) playlists. By using the “shout out” feature (208), the user has the option of inserting voice messages, video and other multi media content (“shout outs”) into her personal broadcast stream before (e.g., pre-roll), during and/or after a content track. The user can also choose to include “shout backs” received from other users into the broadcast stream before, during and/or after a content track. According to certain embodiments, users can add content (e.g., music or other multimedia) of their own creation to the playlist and/or add user-purchased content tracks (e.g., from music CDs) or tracks from their personal content library.

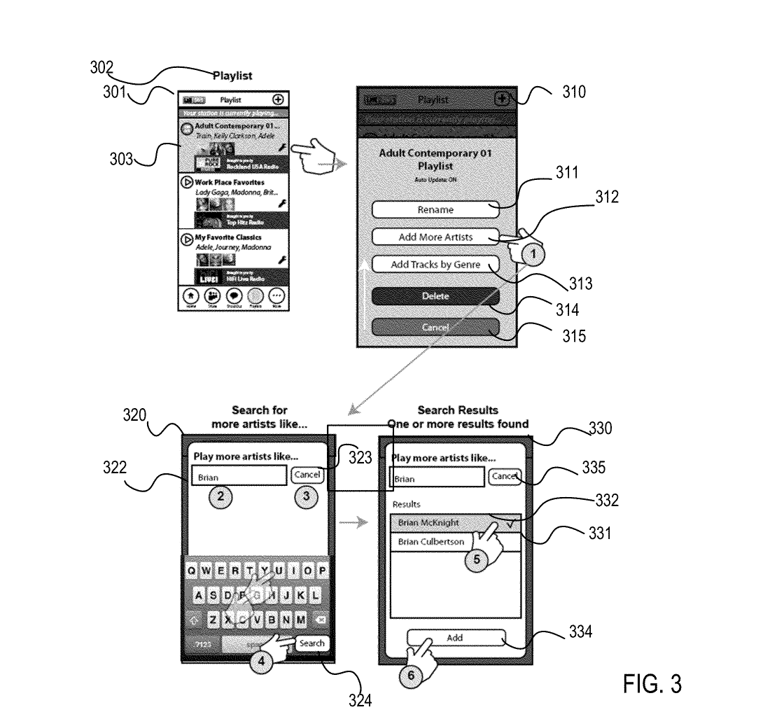

FIG. 3 illustrates some customization features of the radio network system and its associated subscription service, according to certain embodiments. FIG. 3 illustrates a GUI (301) that displays the user's playlists (303). The user can select (302) one of the playlists in order to customize the selected playlist. For example, the user can rename (311) the selected playlist, add more artists (312) or add genre (313) as shown in GUI (310). By using the “add more artists” (312) option, the user can add tracks similar to tracks of an artist selected by the user. By using the “add tracks by genre” (313) option, the user can add tracks to the genre selected by the user. The user can remove tracks using the delete (314) option. The user can use the cancel (315) option to exit the GUI for customization of the playlists. When the user uses the “add more artists” (312) then GUI (320) enables the user to type in a name (322) to search for artists (324). The user has the option of cancelling (323) the search. GUI (330) shows one or more artists as the search results (331). The user can select (332) one of the artists and add (334) the selected artist. According to certain embodiments, the above customization features can apply to any multimedia content playlists and are not restricted to music playlists. For example, customization features can include an “add topic” feature.

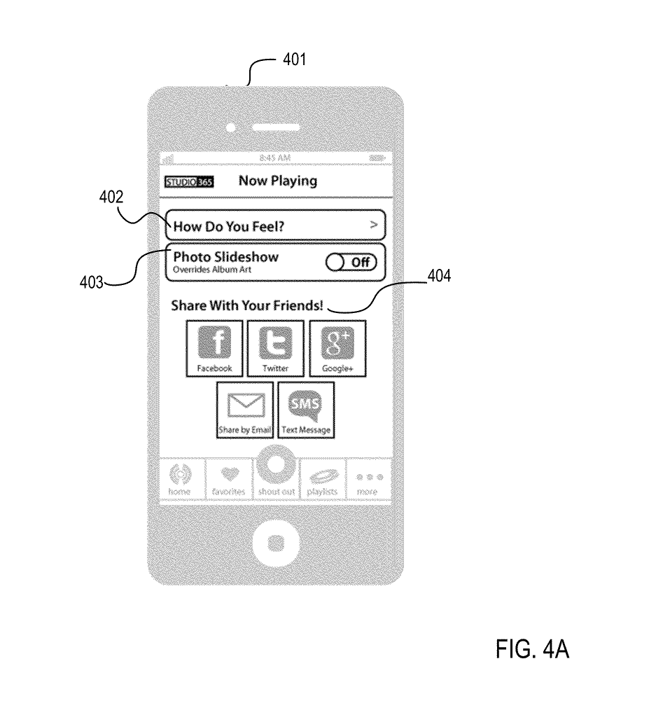

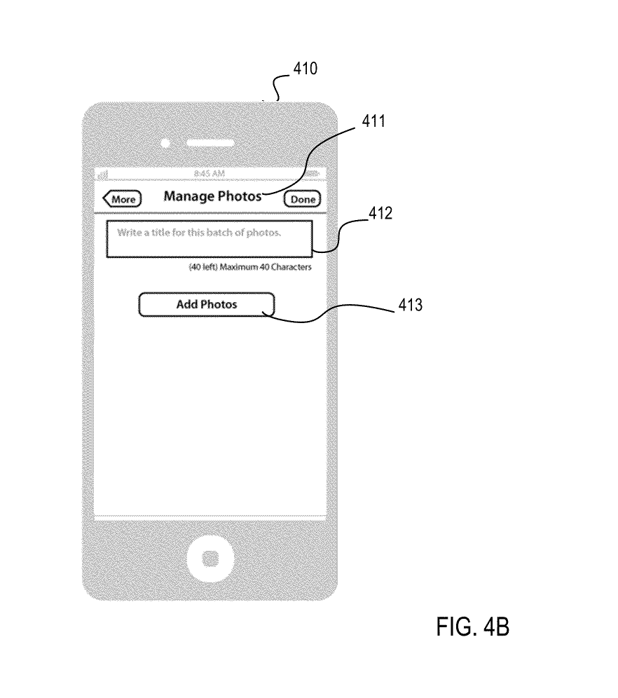

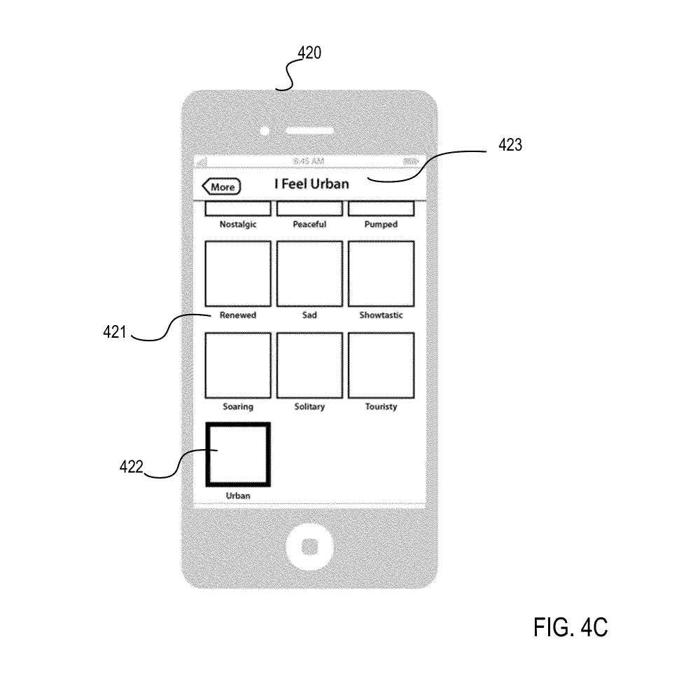

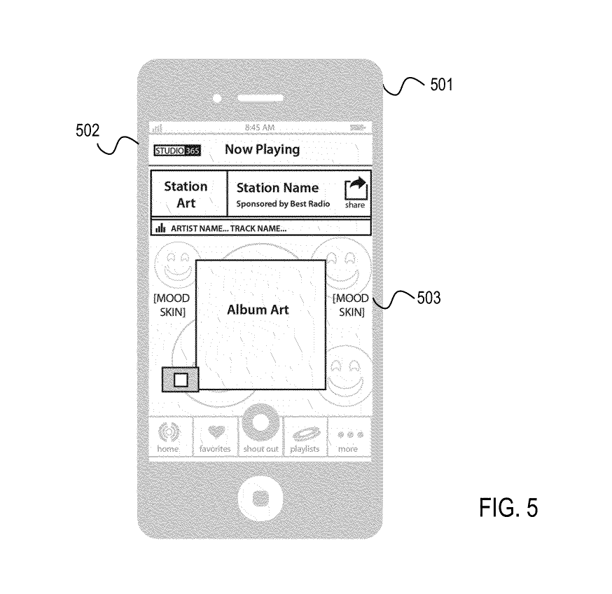

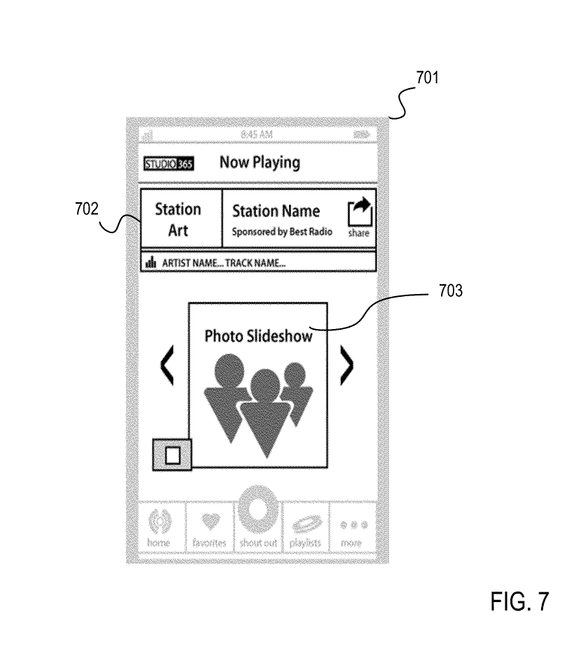

As previously explained, a user can share content from her computer-implemented personal radio station. FIGS. 4A-C illustrate some of the features offered by the radio network system that make broadcasting from a computer-implemented personal radio interesting to the user's audience, according to certain embodiments. FIG. 4A shows features that a user can employ to customize her/his computer-implemented personal radio station. GUI 401 of FIG. 4A shows a “mood” (402) option that the user can use to “skin” her radio station. According to certain embodiments, this skin is a graphic/photo/drawing/video that appears as part of the broadcast on the radio station player of any listener that has tuned in to a given user's computer-implemented radio station as described in further detail herein with reference to FIG. 4C and FIG. 5. The user's computer-implemented station player and the listener's computer-implemented station player can be a mobile device or desktop computer that can access the radio network system and associated subscription service. FIG. 4A also shows a photo slide (403) option by which the user can display a photo slide show as part of her computer-implemented personal radio program as described in further detail herein with reference to FIG. 4B and FIG. 7. FIG. 4A also shows that the user can share her computer-implemented personal radio station with others, such as her friends and family by using the sharing (404) option via email, text messaging, and/or various social networks (such as commercially available products Facebook, Twitter, Google Plus, Tumblr, etc.). In FIG. 4B, GUI 410 shows features in the radio network system that enable the user to manage her photo slide show. The user can view and select photos (411) and include text (412) to accompany the selected batch photos and add (413) such photos for her photo slide show. In FIG. 4C, GUI 420 shows that a user can create a mood by “skinning” her computer-implemented personal radio program by selecting from a variety of moods (421). GUI 420 shows that the urban mood (422) is selected (423). The urban mood appears as a skin on a listener's player when the listener tunes in to this user's computer-implemented personal radio station. The user can use such personalization features at any time to skin the player experience for the user's listeners that have tuned in to the user's computer-implemented broadcast radio station, according to certain embodiments.

FIG. 5 illustrates a listener's player or a broadcaster/user's player (501) that shows the “mood skin” (503) and station information (502) such as station art, station name, sponsor information, current track and artist information as previously explained herein. Thus, the user may further express herself visually and her listeners can enjoy a user-designed “skinned” radio.

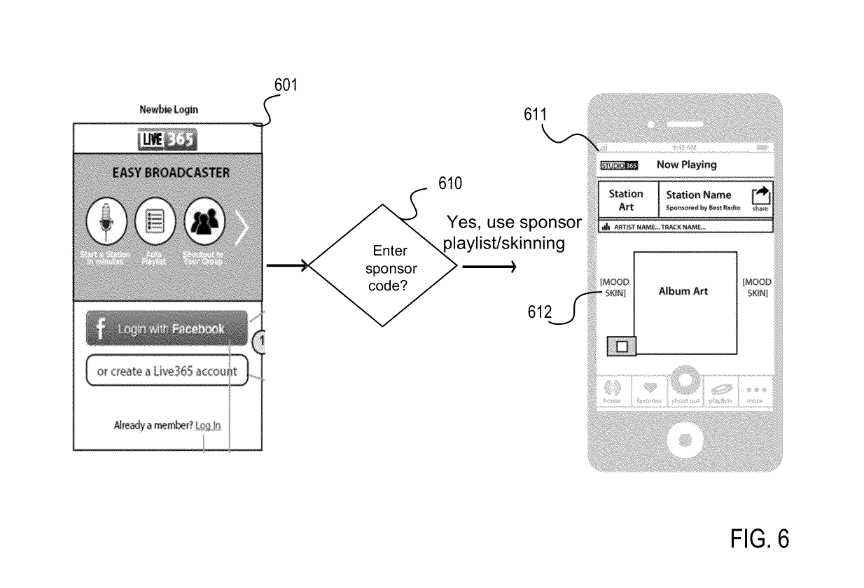

FIG. 6 illustrates features based on sponsorship, according to certain embodiments. FIG. 6 shows that a new user can register to begin using the broadcasting application (601) associated with the radio network system and to obtain a sponsored playlist (and/or other content) by entering a sponsor code (610). If the user enters a legitimate sponsor code, then the user gets access to the sponsored playlist (and/or other content) and the user's computer-implemented broadcast radio player (611) is “skinned” with a mood skin (612) associated with the sponsor. For example, such a sponsor's mood skin may include elements that are beneficial to the sponsor such as branding elements, advertising elements, promotion information, etc. According to certain embodiments, the user may also get different types of content associated with the sponsor when the user enters a sponsor code.

FIG. 7 illustrates a broadcaster/user's player or a listener's player (701) that includes a photo slideshow display (703) and station information (702). According to certain embodiments, the user can use photos/videos that are stored on her mobile device player (or other computer), or the user can import photos/videos from social media (e.g., Facebook, Instagram, etc.) accounts or from some other photo/video hosting site or photo/video sharing service. According to certain embodiments, the user can use the photo slideshow feature to send event invitations, electronic greeting cards, etc., to others, such as her friends.

According to certain embodiments, a user can use the computer-implemented personal radio station to broadcast content on multiple channels at the same time. Each channel can have different playlists, skinning, photo slideshows and its own set of shout outs and shout backs, for example. According to certain embodiments, a user may have channels that are dedicated for special purposes or for special audiences. For example, a user may operate a channel dedicated to streaming music, and or streaming announcements, and e-invitations to neighbors. As another example, a user may operate a channel dedicated to sending messages and e-cards to family members. The user can change the content and purpose of her various channels at any time, according to certain embodiments. For example, a channel dedicated to streaming e-cards to her daughter on her daughter's birthday can be changed to streaming neighborhood announcements to her neighbors on the next day or another at a different time slot on the same day.

According to certain embodiments, the radio network system enables a user to be notified of specific times by her own computer-implemented radio station that she created using the radio network system. In other words, the user sets her station up as an alarm system. For example, the user may use the radio network system to wake her to her own computer-implemented personal radio station, similar to use as an alarm clock.

According to certain embodiments, a user can use the radio network system to view advanced statistics about her computer-implemented personal radio station. For example, the statistics can include information on how many listeners are tuned in to her station, at what hour(s), from which parts of the world, as well as to collect and maintain listener profile data of individuals or in specified groupings, and listener choices.

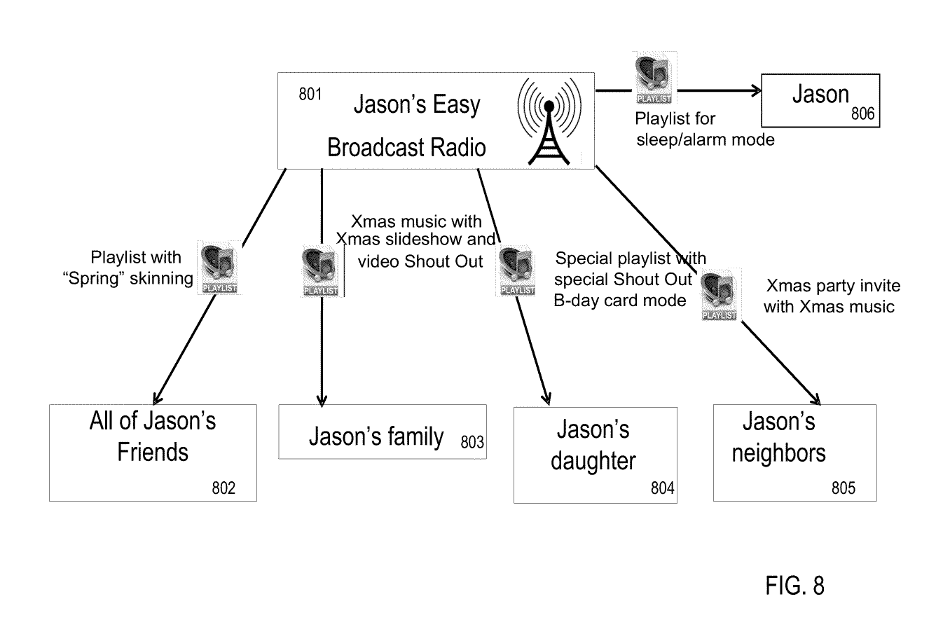

FIG. 8 illustrates a user's use of multiple channels enabled by the radio network system and its associated service, according to certain embodiments. FIG. 8 shows user-Jason's computer-implemented personal radio 801 that has multiple channels. Jason has the option of using each channel for a specific purpose. Further, Jason has the option of broadcasting programs/content with a specific “skinning” at each channel. FIG. 8 shows that user-Jason has a channel 802 that broadcasts a playlist with “Spring” mood skin to Jason's friends, a channel 803 that broadcasts Christmas music with a Christmas slideshow and a video shout out to Jason's family, a channel 804 that broadcasts a special playlist with a special shout out in birthday card mode to Jason's daughter, a channel 805 that broadcasts Christmas party invitation with Christmas music to Jason's neighbors, and a channel 806 that broadcasts a playlist that Jason can use as an alarm clock (for example, Jason wakes up to music on this channel).

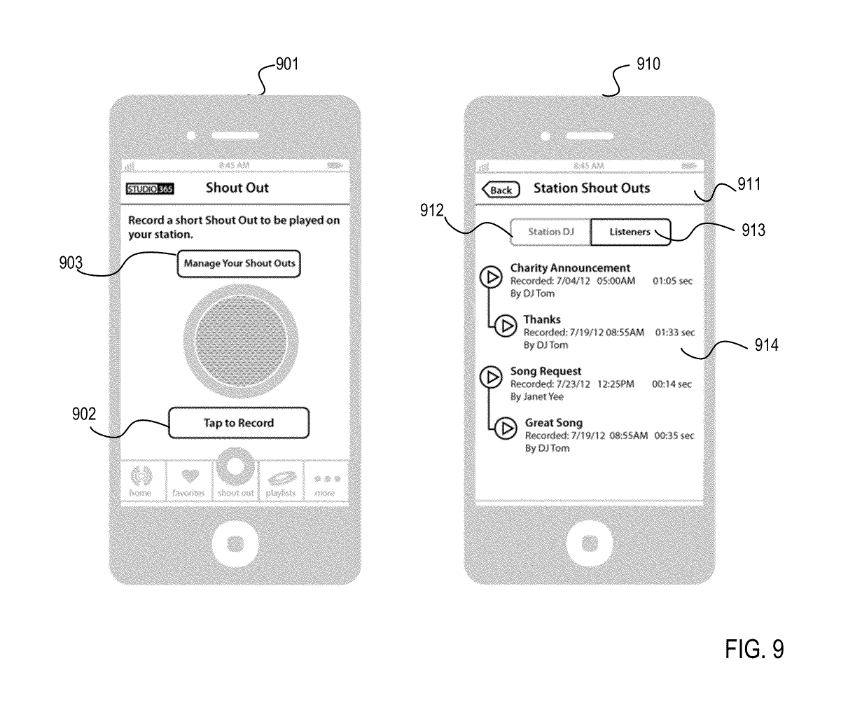

FIG. 9 illustrates a way for a user to project her voice and/or other content into her computer-implemented personal radio program, according to certain embodiments. GUI (901) shows that a user can use the shout out feature to record her voice messages called “shout outs” using the record option (902). The user can also manage (903) her shout outs. GUI (910) illustrates some aspects of managing station shout outs (911) by the user. The user/DJ can select her recorded shout outs (912) or select the shout backs (913) received from listeners or other users/DJs. As an example, GUI (910) displays details (914) of some of the stored shout outs. For example, shout outs and shout backs are audio comments, multimedia content, announcements, or other forms of expression, etc. According to certain embodiments, video, photos, graphics, or other multimedia content can be added to the user's broadcast stream when the user's voice shout out is being broadcast. According to other embodiments, the shout out (or shout back) itself is in the form of video or other multimedia content. The shout out or shout back can be broadcast before, during or after a user's content track is playing. For example, the streaming of a music track can be interrupted with one or more shout outs or shout backs. Similarly, one or more shout outs or shout backs can be played before, during or after any radio program, such as a news program or talk show program, at the discretion of the user. According to certain embodiments, the user can use a sprinkle mode to sprinkle shout outs and shout backs into her broadcast stream in a more or less randomized manner.

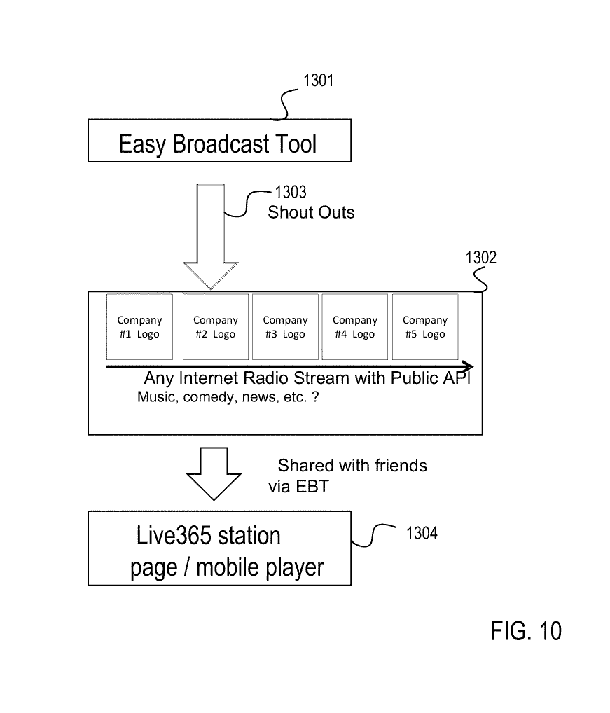

FIG. 10 illustrates the use of the radio network system in partnership with various digital media parties (e.g., internet radio companies) to proliferate and distribute content, according to certain embodiments. FIG. 10 shows a user using the broadcast tool/application (1301) associated with the radio network system to include content (1302) from other computer-implemented radio companies with the user's own content (1303) for broadcast to listeners (1304).

We claim:

1. A method comprising providing a digital platform including interactive tools to a plurality of consumers to enable a consumer of the plurality of consumers to be a broadcaster of content, via streaming, by hosting a personal radio station of the consumer and simultaneously to be a consumer of content broadcasted, via streaming, by other consumers of the plurality of consumers.

2. The method of claim 1, further comprising providing a multi-directional communication network to enable a consumer to share and distribute content via the consumer's personal radio station by using one or more of: shout outs, shout backs, and call-ins.

3. The method of claim 1, further comprising enabling the consumer to interact with other consumers that are hosting respective personal radio stations.

4. The method of claim 1, further comprising enabling the consumer to access content of other consumers of the plurality of consumers.

5. The method of claim 1, further comprising providing the consumer access to professionally programmed playlists, wherein a subset of the playlists can be modified by the consumer.

6. The method of claim 1, further comprising enabling the consumer to personalize the consumer's personal radio station by displaying photo slides or other multimedia as part of a broadcast received on a respective listener's radio station player.

7. The method of claim 1, further comprising enabling the consumer to broadcast through the consumer's personal radio station one or more of the following: music that the consumer has created, music that the consumer has previously purchased, professional customized playlists, and content that the consumer has created or borrowed, wherein content includes one or more of video, graphics, audio, photographs, slide shows, and multimedia content.

8. The method of claim 1, further comprising enabling the consumer to perform one or more of the following: buy content, sell content, and modify content of the personal radio station.

9. The method of claim 8, further comprising enabling monetization and sponsorship.
